(19) United States
(12) Patent Application Publication
(10) Pub. No.: US 2021/0024803 A1
(43) Pub. Date: Jan. 28, 2021

(54) RESIN MEMBER, METHOD FOR PRODUCING RESIN MEMBER AND HEAT STORAGE BODY

(71) Applicant: HITACHI CHEMICAL COMPANY, LTD., Tokyo (JP)

(72) Inventors: Keiko KIZAWA, Chiyoda-ku, Tokyo (JP); Akira NAGAI, Chiyoda-ku, Tokyo (JP); Tsuyoshi MORIMOTO, Chiyoda-ku, Tokyo (JP); Naoki FURUKAWA, Chiyoda-ku, Tokyo (JP); Nozomi MATSUBARA, Chiyoda-ku, Tokyo (JP)

(21) Appl. No.: 17/044,328

(22) PCT Filed: Apr. 4, 2018
(86) PCT No.: PCT/JP2018/014397

§ 371 Date: Oct. 1, 2020

(51) Int. Cl. C09K 5/06; C08F 210/02; C08K 5/101; C08K 5/098; C08K 3/04; C08K 7/24; C08K 13/02; C08J 3/20; B29C 45/00; B29C 43/00; F28D 20/02

(52) U.S. Cl. CPC C09K 5/063; C08F 210/02; C08K 5/101; C08K 5/098; C08K 3/04; B29K 2023/08; C08K 13/02; C08J 3/201; B29C 45/0001; B29C 43/003; F28D 20/02; C08K 7/24

(57) ABSTRACT

A resin member contains a copolymer of ethylene and an olefin having 3 or more carbon atoms, and a fatty acid ester.

### TECHNICAL FIELD

The present invention relates to a resin member, a method of producing a resin member, and a heat storage body.

### BACKGROUND ART

Conventionally, heat storage materials are provided for temporarily saving thermal energy in order to take out thermal energy from time to time in air-conditioning equipment in automobiles, buildings, underground malls, automobile engines, electronic components, and the like.

Examples of the heat storage material include a material accumulating or dissipating heat by utilizing a phase transition of a substance. As such a heat storage material, for example, a material using hydrocarbon compounds is known. Hydrocarbon compounds have excellent heat storage properties by reversibly undergoing phase transition. However, since hydrocarbon compounds are in a liquid state on the high temperature side of the phase transition and may bleed out, some kind of bleeding prevention measures must be applied.

In response to such a problem, for example, Patent Literature 1 discloses a heat storage material containing a styrene-ethylene-ethylene-propylene-styrene copolymer and a paraffin-based wax, as a heat storage material suppressing bleeding.

### CITATION LIST

### Patent Literature

Patent Literature 1: Japanese Unexamined Patent Publication No. 2014-88517

### SUMMARY OF INVENTION

### Technical Problem

However, the heat storage material may be used while being wound around an object in a pulled state, for example. In such a case, the heat storage material is required to have small distortion with respect to tensile force (that is, a high elastic modulus).

The present invention has been made in view of such circumstances, and an object thereof is to provide a resin member capable of storing heat and having a high elastic modulus, a production method therefor, and a heat storage body using the resin member.

### Solution to Problem

In an embodiment, the present invention relates to a resin member comprising a copolymer of ethylene and an olefin having 3 or more carbon atoms, and a fatty acid ester. In this embodiment, the resin member may further comprise a gelling agent. In this embodiment, the resin member may further comprise at least one selected from the group consisting of a carboxylic acid and a carboxylic acid metal salt.

In another embodiment, the present invention relates to a method of producing a resin member, the method including steps of heating and melting a composition comprising a copolymer of ethylene and an olefin having 3 or more carbon atoms, and a fatty acid ester, and molding the composition. In this embodiment, the composition may further comprise a gelling agent. In this embodiment, the composition may further comprise at least one selected from the group consisting of a carboxylic acid and a carboxylic acid metal salt. In these production methods, the molding may be injection molding, compression molding, or transfer molding.

In the above-described respective embodiments, the number of carbon atoms of the olefin may be 3 to 8.

In the above-described respective embodiments, in a case where the melting point of the fatty acid ester is lower than 50° C., the number of carbon atoms of the olefin is preferably 8.

In the above-described respective embodiments, the resin member may further comprise a filler comprising at least one selected from the group consisting of a metal, a carbon material, an inorganic oxide, and an inorganic nitride.

In another embodiment, the present invention relates to a heat storage body comprising a heat source and the above-described resin member attached to the heat source.

### Advantageous Effects of Invention

According to the present invention, it is possible to provide a resin member capable of storing heat and having a high elastic modulus, a producing method therefor, and a heat storage body using the resin member.

### BRIEF DESCRIPTION OF DRAWINGS

FIG. 1 is a schematic cross-sectional view illustrating an embodiment of a resin member.

FIG. 2 is a graph showing a measurement result of an elastic modulus of Example 1.

FIG. 3 is a graph showing a measurement result of an elastic modulus of Example 3.

FIG. 4 is a graph showing a result of a temperature change test.

FIG. 5 is a graph showing a measurement result of thermal response.

FIG. 6 is a graph showing an evaluation result of volatility.

### DESCRIPTION OF EMBODIMENTS

Hereinafter, embodiments of the present invention will be specifically described with reference to the drawings as appropriate.

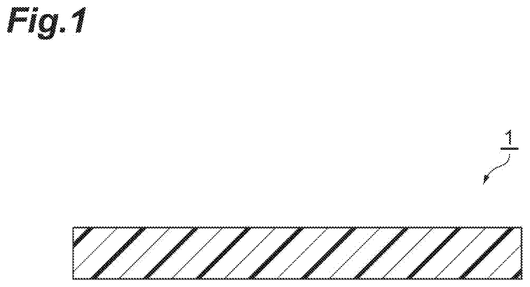

FIG. 1 is a schematic cross-sectional view illustrating an embodiment of a resin member. In an embodiment, a resin member 1 comprises a copolymer of ethylene and an olefin having 3 or more carbon atoms (hereinafter, also referred to as the “component (A)”) and a fatty acid ester (hereinafter, also referred to as the “component (B)”). The resin member 1 may be, for example, in the form of a sheet (film).

The number of carbon atoms of the olefin constituting the copolymer (hereinafter, also simply referred to as “olefin”) is 3 or more and, for example, 3 to 8. In a case where the number of carbon atoms of the olefin is 4 or more, the olefin may be linear or branched. Examples of the copolymer of ethylene and an olefin having 3 or more carbon atoms include a copolymer of ethylene and propylene (C3), a copolymer of ethylene and butene (C4), a copolymer of ethylene and pentene (C5), a copolymer of ethylene and hexene (C6), a copolymer of ethylene and heptene (C7), a copolymer of ethylene and octene (C8), a copolymer of ethylene and nonene (C9), and a copolymer of ethylene and decene (C10). Incidentally, the value in parentheses shown in the specific examples indicates the number of carbons. Of these, a copolymer of ethylene and an olefin having 3 to 8 carbon atoms is preferably used since the copolymer is easily available. The copolymer of ethylene and an olefin having 3 or more carbon atoms may be used alone or in combination of two or more kinds thereof.

The content of the component (A) is preferably 5% by mass or more, more preferably 10% by mass or more, and further preferably 15% by mass or more on the basis of the total amount of the resin member, from the viewpoint of further improving the elastic modulus of the resin member 1. The content of the component (A) is preferably 50% by mass or less, more preferably 40% by mass or less, and further preferably 30% by mass or less on the basis of the total amount of the resin member.

When the resin member 1 comprises the component (A), the elastic modulus of the resin member 1 can be improved, and thus the resin member 1 is suitably used in the case of being wound around an object in a pulled state. Furthermore, when the resin member 1 comprises the component (A), the resin member 1 can favorably maintain an elastic modulus also with respect to a change in environmental temperature. That is, even when the elastic modulus of the resin member 1 is decreased once according to an increase in environmental temperature, the shape can be maintained without the resin member 1 flowing, and when the environmental temperature returns to the original temperature, the elastic modulus measured in a pulling mode of the resin member 1 is likely to return to the original elastic modulus.

From the viewpoint of obtaining a heat storage effect within a practical range, the component (B) has a melting point within a range of −40° C. to 70° C., for example. The component (B) may be, for example, an ester of a fatty acid and an aliphatic alcohol. The component (B) may be linear or branched.

The number of carbon atoms of the fatty acid is preferably 10 or more, and is, for example, 10 to 40, 10 to 30, or 10 to 25. The number of carbon atoms of the aliphatic alcohol is, for example, 1 to 20, 1 to 10, or 1 to 8. The aliphatic alcohol may be, for example, monohydric to trihydric alcohols, and is preferably a monohydric alcohol. In a case where the aliphatic alcohol is a dihydric or higher polyhydric alcohol, the fatty acid ester may be a partial ester obtained by esterifying a part of the hydroxyl group of the polyhydric alcohol or may be a complete ester obtained by esterifying the whole part of the hydroxyl group of the polyhydric alcohol.

Specific examples of the component (B) include glycerol monomyristate (44° C. to 48° C.), methyl stearate (37° C. to 41° C.), ethyl stearate (33° C. to 35° C.), butyl palmitate (32° C. to 35° C.), ethyl palmitate (18° C. to 21° C.), butyl stearate (22° C. to 24° C.), ethyl myristate (10° C. to 13° C.), 2-ethylhexyl stearate (10° C.), methyl laurate (5° C.), tallow fatty acid 2-ethylhexyl ester (1C), 2-ethylhexyl palmitate (0° C.), isopropyl myristate (−5° C.), ethyl laurate (−10° C.), methyl oleate (−20° C.), and ethyl oleate (−32° C.). Incidentally, the values in parentheses shown in the specific examples indicate melting points, respectively. Furthermore, the above-described melting point is a temperature at the point where the baseline crosses the tangent line of the maximum slope of the melting (endothermic) peak of the thermogram obtained in heating at a temperature increasing rate of 10° C./min by using a differential scanning calorimeter (for example, “8500” manufactured by PerkinElmer Inc.). These components (B) may be used alone or in combination of two or more kinds thereof.

Since there is a tendency that the fatty acid ester is less likely to volatilize even in a temperature zone exceeding the melting point as compared to a linear saturated hydrocarbon compound or petroleum wax containing a linear saturated hydrocarbon compound as a main component, the properties of the resin member can be stably maintained for a long time.

The content of the component (B) is preferably 40% by mass or more, more preferably 45% by mass or more, and further preferably 50% by mass or more on the basis of the total amount of the resin member, from the viewpoint of having a further excellent heat storage effect. The content of the component (B) is preferably 90% by mass or less, more preferably 80% by mass or less, and further preferably 70% by mass or less on the basis of the total amount of the resin member.

In a case where the melting point of the component (B) is lower than 50° C., the number of carbon atoms of the olefin in the component (A) is preferably 8 from the viewpoint of superior suppression of fluidity of the fatty acid ester.

The resin member 1 may further comprise a gelling agent (hereinafter, also referred to as the “component (C)”) in addition to the copolymer of ethylene and an olefin having 3 or more carbon atoms and the fatty acid ester. The component (C) is not particularly limited as long as it is a component capable of gelling the component (B). The component (C) may be, for example, a carboxylic acid or a carboxylic acid metal salt. That is, in another embodiment, the resin member 1 may further comprise at least one selected from the group consisting of a carboxylic acid and a carboxylic acid metal salt, in addition to the copolymer of ethylene and an olefin having 3 or more carbon atoms and the fatty acid ester.

The carboxylic acid in the component (C) is preferably a carboxylic acid having a straight-chain hydrocarbon group, from the viewpoint of good compatibility with the fatty acid ester. The number of carbon atoms of the carboxylic acid is preferably 10 or more, and is, for example, 10 to 40, 10 to 30, or 10 to 25. The carboxylic acid may be saturated or unsaturated. The carboxylic acid is not particularly limited, and examples thereof include lauric acid (C12 (the number of carbon atoms, the same applies below)), myristic acid (C14), palmitic acid (C16), stearic acid (C18), isostearic acid (C18), docosahexaenoic acid (C22), behenic acid (C21), undecylenic acid (C11), oleic acid (C18), erucic acid (C22), linoleic acid (C18), arachidonic acid (C20), linolenic acid (C18), sapienic acid (C16), and 12-hydroxystearic acid (C18). The carboxylic acid may be used alone or in combination of two or more kinds thereof.

The carboxylic acid constituting the carboxylic acid metal salt in the component (C) is preferably a carboxylic acid having a straight-chain hydrocarbon group (straight-chain aliphatic carboxylic acid), from the viewpoint of good compatibility with the fatty acid ester and the carboxylic acid. The number of carbon atoms of the carboxylic acid constituting the carboxylic acid metal salt is preferably 6 or more, and is, for example, 6 to 30, 6 to 25, or 8 to 20. The carboxylic acid constituting the carboxylic acid metal salt may be saturated or unsaturated. The metal constituting the carboxylic acid metal salt is a metal capable of forming salts with a carboxylic acid, and is, for example, aluminum. Specific examples of the carboxylic acid metal salt include aluminum stearate (C18 (the number of carbon atoms, the same applies below)), aluminum laurate (C12), aluminum oleate (C18), aluminum behenate (C21), aluminum palmitate (C16), and aluminum 2-ethylhexanoate (C8). The carboxylic acid metal salt may be used alone or in combination of two or more kinds thereof.

In a case where the resin member 1 comprises the component (C), the content of the component (C) is preferably 3% by mass or more on the basis of the total amount of the resin member. The content of the component (C) is preferably 10% by mass or less, more preferably 8% by mass or less, and further preferably 6% by mass or less on the basis of the total amount of the resin member.

From the viewpoints of imparting thermal conductivity to the resin member 1 and improving thermal responsiveness, the resin member 1 may further comprise a filler comprising at least one selected from the group consisting of a metal, a carbon material, an inorganic oxide, and an inorganic nitride (hereinafter, also referred to as the “component (D)”). The shape of the filler may be a powder shape, a particulate shape, a fibrous shape, or the like. When the resin member 1 comprises a filler, the thermal responsiveness of the resin member is improved, and thereby heat is easily transferred also to a part of the resin member away from the heat source, so that a volume with which heat can be effectively stored can be increased.

The metal which may be contained in the component (D) may be at least one selected from the group consisting of gold, silver, copper, and aluminum. The carbon material may be at least one selected from the group consisting of graphite, carbon fiber, and carbon powder. The graphite may be natural graphite such as spheroidal graphite, expanded graphite, scale-like graphite, and amorphous graphite, and may be artificial graphite such as pyrolytic graphite. The inorganic oxide may be at least one selected from the group consisting of alumina, silica, and beryllium oxide. The inorganic nitride may be at least one selected from the group consisting of aluminum nitride and boron nitride. The component (D) may be a resin filler or silica filler in which a resin or silica is covered with the metal, the carbon material, the inorganic oxide, or the inorganic nitride described above.

In a case where the resin member 1 comprises the component (D), the content of the component (D) is preferably 5% by mass or more and preferably 35% by mass or less, more preferably 30° by mass or less, and further preferably 25% by mass or less on the basis of the total amount of the resin member.

In a case where the melting point of the component (B) is 50° C. or higher, from the viewpoint of the resin member 1 being further excellent in suppressing flowability and maintaining the shape in a temperature range of 50° C. or higher, the resin member 1 preferably further comprises at least one selected from the group consisting of polyethylene (ethylene homopolymer) and polypropylene (propylene homopolymer)(hereinafter, also referred to as the “component (E)”).

The content of the component (E) may be 5% by mass or more, and may be 30% by mass or less, 25% by mass or less, or 20% by mass or less on the basis of the total amount of the resin member.

The resin member 1 may further comprise other components in addition to the above-described components (A) to (E). Examples of the other components include inorganic components such as glass and tale, light absorbing agents suppressing photodegradation, and antioxidants suppressing oxidation degradation. The content of the other components may be, for example, 10% by mass or less on the basis of the total amount of the resin member.

The resin member 1 described above can be obtained, for example, by the following method. That is, in a state where the fatty acid ester (component (B)) is heated to the melting point or higher, the copolymer of ethylene and an olefin having 3 or more carbon atoms (component (A)), and as necessary, the filler (component (D)) and at least one selected from the group consisting of polyethylene and polypropylene (component (E)) are added and mixed. After homogeneously mixing, the carboxylic acid and the carboxylic acid metal salt (component (C)) may be added, and the resultant product is further homogeneously mixed to obtain the resin member 1.

The resin member 1 is also obtained by heating and melting a composition comprising the component (A), the component (B), and as necessary, the components (C) to (E), and other components and molding the composition. That is, the method of producing the resin member 1 comprises steps of: heating and melting a composition comprising the component (A), the component (B), and as necessary, the components (C) to (E), and other components and molding the composition (molding step). The molding in the molding step may be injection molding, compression molding, or transfer molding.

As described above, since the resin member 1 can store heat or dissipate heat by utilizing phase transition, the resin member 1 is suitably used as a heat storage material. In other words, in the above description, “resin member” can be read as “heat storage material”. That is, the heat storage material of an embodiment comprises a copolymer of ethylene and an olefin having 3 or more carbon atoms, and a fatty acid ester.

The heat storage material (resin member) of the present embodiment can be utilized in various fields. The heat storage material (resin member) is used for, for example, air-conditioning equipment in automobiles, buildings, public facilities, underground malls, and the like (improvement in efficiency of air-conditioning equipment); (pipe-shaped) plumbing in factories and the like (heat storage of plumbing); heat exchange machines or heat exchange plumbing of heat pumps in temperature adjusting apparatuses (heat storage of plumbing); automobile engines (heat insulation around the engines); electronic components (prevention of temperature increase of electronic components), underwear fibers; and the like. Since the heat storage material (resin member) does not need a casing and the heat storage material (resin member) alone has a high elastic modulus, the heat storage material (resin member) can be pasted to, wound around, or attached in various states to the object (heat source) to be attached. That is, an embodiment of the present invention can relate to a heat storage body comprising a heat source (object) and the above-described heat storage material (resin member) attached to the heat source.

### EXAMPLES

The present invention will be specifically described on the basis of Examples; however, the present invention is not limited to these Examples.

In Examples, Reference Example, and Comparative Examples, each of components described below was used to prepare resin members having the compositions shown in Tables 1 to 3. That is, in a state where the fatty acid ester (component (B)) was heated to the melting point or higher, the copolymer of ethylene and an olefin having 3 or more carbon atoms (component (A)), and as necessary, the filler (component (D)) were added and mixed. After homogeneously mixing, as necessary, the carboxylic acid and/or the carboxylic acid metal salt (component (C)) was added, and the resultant product was further homogeneously mixed to obtain the resin member. In Reference Example 1, instead of the component (B), a fatty acid ester alternate material described below was used

(Copolymer of Ethylene and Olefin Having 3 or More Carbon Atoms)

A-1: Copolymer of ethylene and octene (product name “ENGAGE8150” manufactured by Dow Chemical Japan, Ltd.)

A-2: Copolymer of ethylene and octene (product name “ENGAGE8003” manufactured by Dow Chemical Japan, Ltd.)

(Fatty Acid Ester)

B-1: Methyl stearate (melting point: 37° C.)

B-2: Ethyl stearate (melting point: 33° C.)

B-3: 2-Ethylhexyl stearate (melting point: 10° C.)

(Fatty Acid Ester Alternate Material)

B-4: Hexadecane (melting point: 18° C.)

(Carboxylic Acid or Carboxylic Acid Metal Salt)

C-1: Oleic acid

C-2: Aluminum 2-ethylhexanoate

C-3: 12-Hydroxystearic acid

(Filler)

D-1: Expanded graphite pulverized powder (Dainen Trading Co., Ltd., average particle diameter: 175 to 250 μm)

(Measurement of Elastic Modulus)

With respect to each of Examples, Reference Example, and Comparative Examples, a resin member having a size of 20 mm×5 mm×1 mm was used as a sample, and the elastic modulus of the resin member in a temperature range of the melting point±15° C. to 30° C. was measured by a dynamic viscoelasticity measuring tester (DVA-220, IT Keisoku Seigyo K.K.). As the temperature condition, after the temperature was increased from a temperature T1 at a temperature increasing rate of 10° C./min to reach a temperature T2, the temperature was decreased at a temperature decreasing rate of 10° C./min to reach a temperature T3 near the temperature T1 so that the temperature became a temperature equal to or higher than the melting point from a temperature lower than the melting point of the resin member. Then, the elastic moduli at the temperatures T1, T2, and T3 were measured. The measurement was executed in a tensile vibration mode under conditions of 10 Hz and a setting distortion of 0.08%. The elastic modulus when the temperature is T1 is designated as E1, the elastic modulus when the temperature is T2 is designated as E2, the elastic modulus when the temperature is T3 is designated as E3, and the respective elastic moduli are shown in Tables 1 to 3.

(Measurement of Melting Point and Heat of Fusion)

With respect to the obtained resin member, the melting point was obtained from the peak temperature of melting in the temperature increasing process at a temperature increasing rate of 10° C./min and the heat of fusion (J/g) was calculated from each area by differential thermal analysis (DSC). The measurement results are shown in Tables 1 to 3. Incidentally, a larger heat of fusion means a larger heat storage capacity.

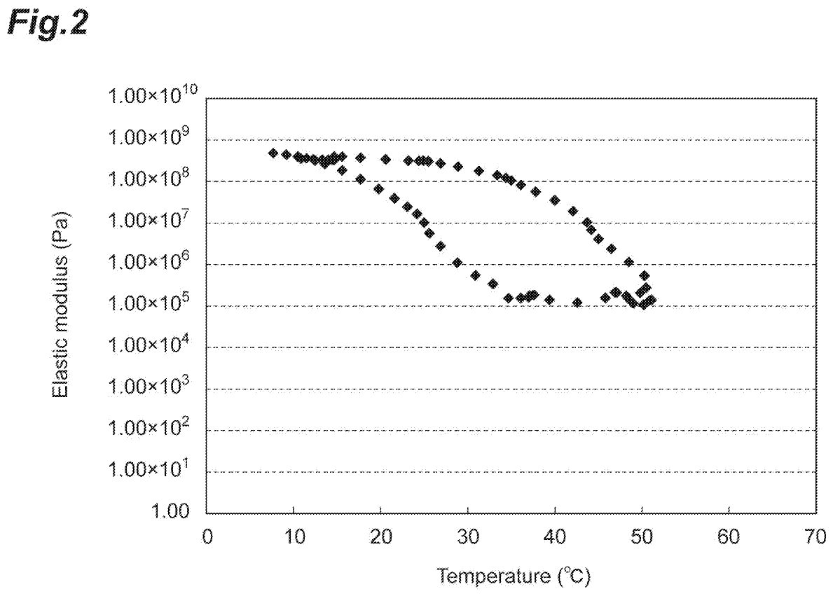

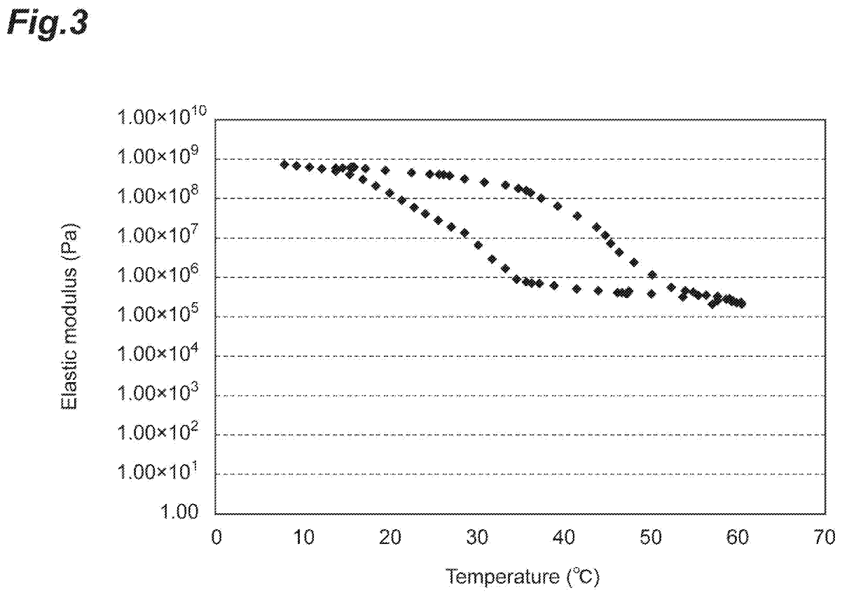

As shown in Tables 1 to 3, the resin members of Examples 1 to 12 had a sufficiently high elastic modulus (for example, the elastic modulus E2 in the pulling mode at a temperature equal to or higher than the melting point of the resin member is 1.00×10² Pa or more) when being used as a heat storage material. Furthermore, a tendency that the elastic modulus after increasing the temperature to the melting point or higher returns to (recovers) the elastic modulus before increasing the temperature to the melting point or higher when the temperatures of the resin members of Examples 1 to 12 are increased and decreased in a temperature range with the melting point of the copolymer interposed therebetween was observed. Incidentally, when E3/E1≥0.05 is established, a tendency that the elastic modulus E3 returns to the elastic modulus E1 can be observed. Therefore, it could be confirmed that, in the resin members of Examples 1 to 12, the temperature increasing and decreasing processes can be repeated. On the other hand, in the resin members of Comparative Examples 1 and 2, the heat of fusion could not be calculated and the resin members did not have a heat storage effect. The resin members of Comparative Examples 3 to 5 were in a liquid state at the melting point or higher, and the elastic modulus could not be measured. That is, it is considered that the resin members of Examples 1 to 12 can be used as a heat storage material which can be used even without being housed in any cases configured by a metal, a resin, or the like. Incidentally, as examples of measurement results of elastic modulus, the measurement results of Examples 1 and 3 are shown in FIG. 2 and FIG. 3.

(Evaluation of Shape Maintaining)

A resin member having a size of 20 mm×50 mm×1 mm was used as a sample, placed on an SUS tray, and left to stand in a thermostat bath set at 60° C. for 24 hours, and the shape change was observed. A case where the shape change was not observed was designated as A, a case where the corner of the sample was slightly rounded was designated as B, and a case where the side of the sample was rounded or the shape flowed was designated as C. The evaluation results are shown in Tables 1 to 3.

TABLE 1

| | | Example 1 | Example 2 | Example 3 | Example 4 | Example 5 | Example 6 |
|---|---|---|---|---|---|---|---|
| Composition | A-1 | 2.8 | 2.8 | — | — | — | — |
| (parts by mass) | A-2 | — | — | 2.8 | 2.8 | 3 | 3 |
| | B-1 | 6.6 | 6.6 | 6.6 | 6.6 | 7 | 7 |
| | B-2 | — | — | — | — | — | — |
| | B-3 | — | — | — | — | — | — |
| | B-4 | — | — | — | — | — | — |
| | C-1 | 0.17 | — | 0.17 | — | — | — |
| | C-2 | 0.33 | — | 0.33 | — | — | — |
| | C-3 | — | — | — | — | — | — |
| | D-1 | — | — | — | — | — | 3 |
| Measurement | T1 | 15 | 15 | 15 | 15 | 15 | 15 |
| temperature of | T2 | 50 | 50 | 60 | 60 | 60 | 60 |
| elastic modulus | T3 | 15 | 15 | 15 | 15 | 15 | 15 |
| (° C.) | | | | | | | |
| Elastic modulus | E1 | 3.32 × 10⁸ | 4.85 × 10⁸ | 5.86 × 10⁸ | 5.02 × 10⁸ | 6.29 × 10⁸ | 6.07 × 10⁸ |
| (Pa) | E2 | 1.32 × 10⁵ | 4.86 × 10⁴ | 2.05 × 10⁵ | 2.96 × 10⁵ | 3.20 × 10⁵ | 9.03 × 10⁶ |
| | E3 | 1.86 × 10⁸ | 3.04 × 10⁸ | 3.98 × 10⁸ | 4.19 × 10⁸ | 3.46 × 10⁸ | 1.39 × 10⁹ |

| | | | | | | |
|---|---|---|---|---|---|---|
| E3/E1 | 0.56 | 0.63 | 0.68 | 0.83 | 0.55 | 2.29 |
| Melting point (° C.) | 42 | 41 | 43 | 42 | 42 | 40 |
| Heat of fusion (J/g) | 145 | 144 | 141 | 137 | 143 | 108 |
| Shape maintaining evaluation | B | B | A | A | A | A |

TABLE 2

| | | Example 7 | Example 8 | Example 9 | Example 10 | Example 11 | Example 12 |
|---|---|---|---|---|---|---|---|
| Composition | A-1 | 2.8 | 2.8 | — | — | — | 2.8 |
| (parts by mass) | A-2 | — | — | 2.8 | 2.8 | 2.8 | — |
| | B-1 | — | — | — | — | 4.4 | — |
| | B-2 | 6.6 | 6.6 | 6.6 | 6.6 | 2.2 | — |
| | B-3 | — | — | — | — | — | 6.6 |
| | B-4 | — | — | — | — | — | — |
| | C-1 | 0.17 | — | 0.17 | — | — | — |
| | C-2 | 0.33 | — | 0.33 | — | — | — |
| | C-3 | — | — | — | — | — | 0.5 |
| | D-1 | — | — | — | — | — | — |
| Measurement | T1 | 15 | 15 | 15 | 15 | 15 | −5 |
| temperature of | T2 | 50 | 50 | 60 | 60 | 60 | 20 |
| elastic modulus | T3 | 15 | 15 | 15 | 15 | 15 | −5 |
| (° C.) | | | | | | | |
| Elastic modulus | E1 | 2.89 × 10⁸ | 1.83 × 10⁸ | 5.01 × 10⁸ | 5.74 × 10⁸ | 3.75 × 10⁸ | 2.55 × 10⁷ |
| (Pa) | E2 | 6.65 × 10⁴ | 1.09 × 10⁵ | 2.94 × 10⁵ | 3.73 × 10⁵ | 2.39 × 10⁵ | 4.37 × 10⁵ |
| | E3 | 4.30 × 10⁷ | 2.29 × 10⁷ | 5.79 × 10⁷ | 3.79 × 10⁷ | 6.42 × 10⁷ | 1.80 × 10⁷ |

| | | | | | | |
|---|---|---|---|---|---|---|
| E3/E1 | 0.15 | 0.13 | 0.12 | 0.07 | 0.17 | 0.70 |
| Melting point (° C.) | 37 | 37 | 38 | 38 | 35 | 7 |
| Heat of fusion (J/g) | 119 | 136 | 121 | 130 | 122 | 72 |
| Shape maintaining evaluation | B | B | A | A | B | B |

TABLE 3

| | | Reference | Comparative | Comparative | Comparative | Comparative | Comparative |
|---|---|---|---|---|---|---|---|
| | | Example 1 | Example 1 | Example 2 | Example 3 | Example 4 | Example 5 |
| Composition | A-1 | 3 | 10 | — | — | — | — |
| (parts by mass) | A-2 | — | — | 10 | — | — | — |
| | B-1 | — | — | — | 10 | — | — |
| | B-2 | — | — | — | — | 10 | — |
| | B-3 | — | — | — | — | — | 10 |
| | B-4 | 7 | — | — | — | — | — |
| | C-1 | 0.18 | — | — | — | — | — |
| | C-2 | 0.35 | — | — | — | — | — |
| | C-3 | — | — | — | — | — | — |
| | D-1 | — | — | — | — | — | — |
| Measurement | T1 | — | 15 | 15 | Unmeasurable | Unmeasurable | Unmeasurable |
| temperature of | T2 | — | 50 | 60 | | | |
| elastic modulus | T3 | — | 15 | 15 | | | |
| (° C.) | | | | | | | |
| Elastic modulus | B1 | — | 1.18 × 10⁷ | 3.34 × 10⁷ | | | |
| (Pa) | E2 | — | 3.97 × 10⁶ | 9.63 × 10⁶ | | | |
| | E3 | — | 8.94 × 10⁶ | 2.87 × 10⁷ | | | |

| | | | | | | |
|---|---|---|---|---|---|---|
| E3/E1 | — | 0.76 | 0.86 | — | — | — |
| Melting point (° C.) | 20 | Unmeasurable | Unmeasurable | 42 | 39 | 7 |
| Heat of fusion (J/g) | 135 | | | 206 | 204 | 109 |
| Shape maintaining evaluation | B | B | A | C | C | C |

(Temperature Change Test)

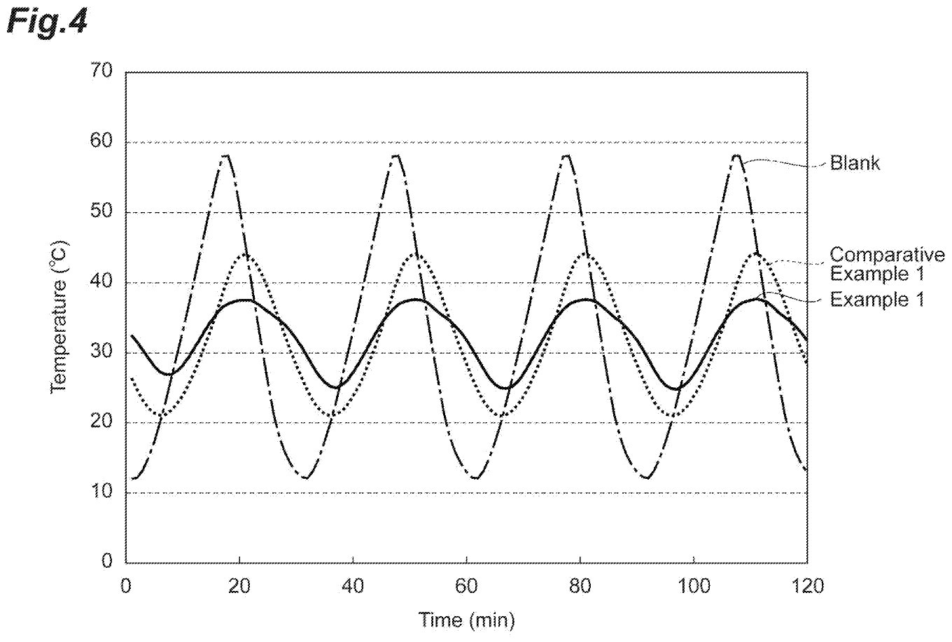

The resin members of Example 1 and Comparative Example 1 adjusted to have a size of 150×150 mm×3 mm were subjected to a temperature change test. The resin member was mounted on a surface of a laminate (size: 200×200 mm) of 3.2 mm-thick glass and a 900 m-thick ethylene-vinyl acetate copolymer at the polymer side and was set in a test bath (PG-2J, ESPEC CORP.). The temperature change of the laminate when the setting temperature was set between 70° C. and 15° C. and at 30 min/cycle was measured. At the time of measurement, as a blank, the temperature change of a laminate on which the resin member was not mounted was also similarly measured. The results are shown in FIG. 4. As compared to the blank and Comparative Example 1, the temperature change of the laminated on which the resin member of Example 1 was mounted was small when the temperature increasing and the temperature decreasing were repeated. Therefore, it was found that the resin member of Example 1 is useful as a resin member having a heat storage effect.

(Measurement of Thermal Response)

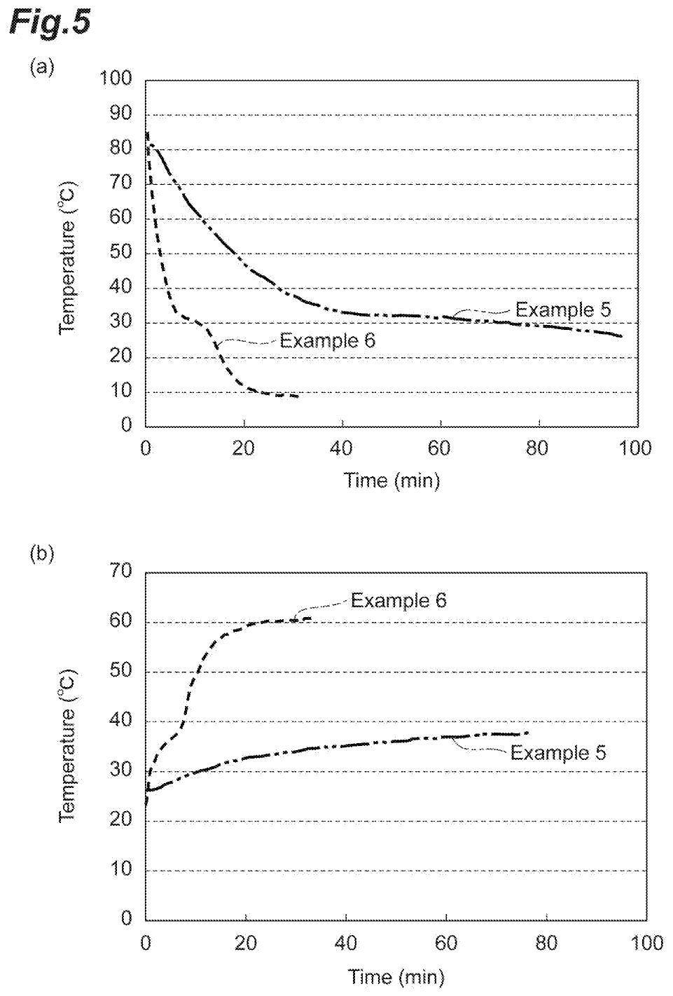

The resin members of Examples 5 and 6 were used, and the thermal response when covering a pipe was measure. A sample in which the resin member having a thickness of 17.5 mm covered the periphery of a copper pipe having a diameter of 6 mm was prepared. After this sample was left to stand in a thermostat bath set at 100° C. for 45 minutes, a pipe for constant-temperature circulating water was connected to the copper pipe, and cold water set at 5° C. was allowed to flow at 1.2 Imin. The change in temperature decrease of the resin member located at a position away from the copper pipe center by 15 mm was measured. The results are shown in FIG. 5(a).

Furthermore, the same sample was sufficiently left to stand at room temperature of about 25° C., after the temperature was stabilized, the pipe for constant-temperature circulating water was connected to the copper pipe, and warm water set at 70° C. was allowed to flow at 1.2 Imin. The change in temperature increase of the resin member located at a position away from the copper pipe center by 15 mm was measured. The results are shown in FIG. 5(b).

The thermal conductivities of the resin members of Example 5 and Example 6 were measured, and as a result, the thermal conductivity of the resin member of Example 5 was about 0.36 W/mK, and the thermal conductivity of the resin member of Example 6 was about 1.11 W/mK. From these results, it was found that, when the resin member contains expanded graphite, the thermal conductivity is further improved, and even in a site away from the copper pipe, the heat storage effect can be exerted in a short time. That is, the resin members of Example 5 and Example 6 could be confirmed to have further usefulness as the heat storage material.

(Evaluation of Volatility)

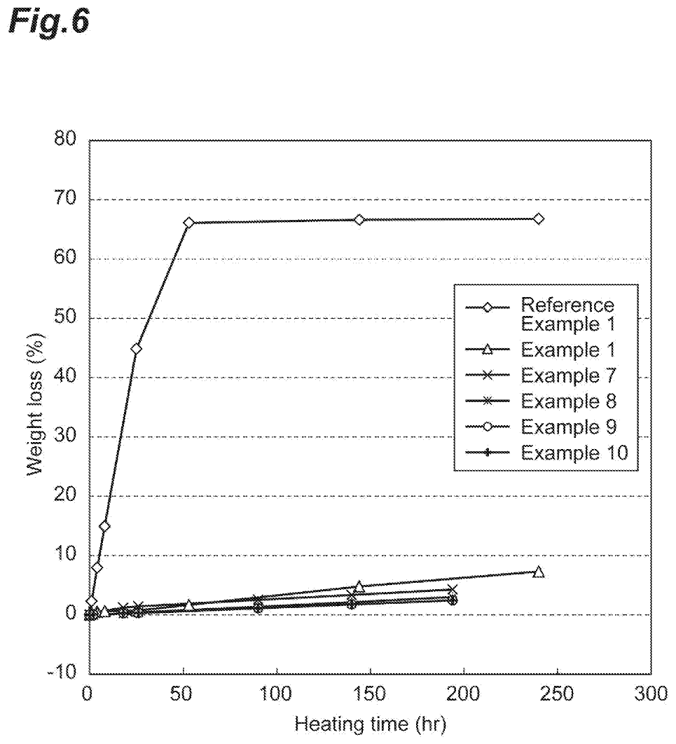

Volatility was evaluated for the resin members of Examples 1 and 7 to 10 and Reference Example 1. A resin member having a size of 50 mm×10 mm×1 mm was charged in a thermostat bath set at 60° C., and the mass change was measured. The results are shown in FIG. 6. It was found that there is a tendency that the resin members of Examples 1 and 7 to 10 containing a fatty acid ester are less likely to volatilize as compared to the resin member of Reference Example 1 not containing a fatty acid ester. Incidentally, the volatile matter content in Reference Example 1 is considered to be hexadecane (B-4 component) from the volatilization volume. Furthermore, it was found that the properties of the resin members of Examples 1 and 7 to 10 can be stably maintained for a long time. For example, it was found that, although the heat of fusion of Example 1 before the test is 142 J/g, the heat of fusion at 60° C. after a lapse of 240 hours is 141 J/g, and the properties of the resin member are maintained even after the volatility evaluation.

As described above, it was found that the resin member (heat storage material) of the present invention can be molded in an arbitrary shape by a molding method, which is generally used, such as injection molding, compression molding, or transfer molding, and since the resin member (heat storage material) has a high elastic modulus even at various temperatures, an effect that the resin member (heat storage material) can be used as a resin member (heat storage material) capable of suppressing a temperature change without a case.

### REFERENCE SIGNS LIST

1: resin member.

1. A resin member comprising:
a copolymer of ethylene and an olefin having 3 or more carbon atoms; and
a fatty acid ester.

2. The resin member according to claim 1, further comprising a gelling agent.

3. The resin member according to claim 1, further comprising at least one selected from the group consisting of a carboxylic acid and a carboxylic acid metal salt.

4. The resin member according to claim 1, wherein a number of the carbon atoms of the olefin is 3 to 8.

5. The resin member according to claim 1, wherein a melting point of the fatty acid ester is lower than 50° C. and a number of the carbon atoms of the olefin is 8.

6. The resin member according to claim 1, further comprising a filler comprising at least one selected from the group consisting of a metal, a carbon material, an inorganic oxide, and an inorganic nitride.

7. A method of producing a resin member, the method comprising steps of:
heating and melting a composition comprising a copolymer of ethylene and an olefin having 3 or more carbon atoms, and a fatty acid ester, and
molding the composition.

8. The method of producing a resin member according to claim 7, wherein the composition further comprises a gelling agent.

9. The method of producing a resin member according to claim 7, wherein the composition further comprises at least one selected from the group consisting of a carboxylic acid and a carboxylic acid metal salt.

10. The method of producing a resin member according to claim 7, wherein the molding is selected from the group consisting of injection molding, compression molding, and transfer molding.

11. The method of producing a resin member according to claim 7, wherein a number of the carbon atoms of the olefin is 3 to 8.

12. The method of producing a resin member according to claim 7, wherein a melting point of the fatty acid ester is lower than 50° C. and a number of the carbon atoms of the olefin is 8.

13. The method of producing a resin member according to claim 7, wherein the composition further comprises a filler comprising at least one selected from the group consisting of a metal, a carbon material, an inorganic oxide, and an inorganic nitride.

14. A heat storage body comprising:
a heat source; and
the resin member according to claim 1, wherein the resin member is attached to the heat source.
